(19) United States
(12) Patent Application Publication
(10) Pub. No.: US 2026/0112564 A1
(43) Pub. Date: Apr. 23, 2026

(54) SOURCE CAPS WITH DIAMOND ANODE TARGETS FOR A RADIATION DELIVERY SYSTEM

(71) Applicant: ILLINOIS TOOL WORKS INC., Glenview, IL (US)

(72) Inventors: Sean Anderson, Otsego, MN (US); Pradeep Bhattad, Plymouth, MN (US); Matthew James Johnson, Rogers, MN (US); Kirk Guillaume, Brooklyn Park, MN (US)

(21) Appl. No.: 19/313,604

(22) Filed: Aug. 28, 2025

Related U.S. Application Data
(60) Provisional application No. 63/693,944, filed on Sep. 12, 2024.

(51) Int. Cl. H01J 35/10

(52) U.S. Cl. CPC H01J 35/10; H01J 2235/086; H01J 2235/1204

(57) ABSTRACT

An example anode target assembly for a radiation delivery system is provided. The anode target assembly includes a body with a first end and a second end. A source cap arranged at the first end of the body, the source cap defined by two or more target surfaces. The target surfaces include recesses to receive a diamond target, which has an exposed surface when mounted in the recess.

### CROSS REFERENCE TO RELATED APPLICATIONS

This application is a Non-Provisional of U.S. Provisional Patent Application No. 63/693,944, entitled “Source Caps With Diamond Anode Targets For A Radiation Delivery System”, filed Sep. 12, 2024, which is herein incorporated by reference in its entirety.

### FIELD OF THE DISCLOSURE

This disclosure relates generally to source caps for radiation delivery systems and, more particularly, to source caps to support and arrange anode targets for a radiation delivery process.

### BACKGROUND

Anode sources for x-ray delivery systems are useful in a variety of industrial application. An anode target can be used to image an object to detect structural damage to metal parts, for example. However, intensity of the x-ray can be limited by the configuration of the source, which can reach extreme temperatures during use. Further, the source can degrade quickly, limiting the useful life of the source. Thus, systems and devices that mitigate heat damage and increase the useful life of the source are desirable.

### SUMMARY

Source caps for radiation delivery systems are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIGS. 1A and 1B illustrate perspective views of an example source cap to support anode target areas, in accordance with aspects of this disclosure.

FIGS. 2A to 2E illustrate example alternative source caps, in accordance with aspects of this disclosure.

FIG. 3 illustrates a cross-sectional view of an example source cap arranged with an anode target assembly, in accordance with aspects of this disclosure.

FIG. 4 illustrates a cross-sectional views of an example source cap arranged within a radiation delivery system, in accordance with aspects of this disclosure.

The figures are not necessarily to scale. Wherever appropriate, similar or identical reference numerals are used to refer to similar or identical components.

### DETAILED DESCRIPTION

Disclosed are example anode source caps and anode target assemblies employing such source caps for use in a radiation delivery system. An example anode target assembly includes a body with a first end and a second end. A source cap arranged at the first end of the body, the source cap defined by two or more target surfaces. The target surfaces may include one or more targets, which has an exposed surface when mounted on the target surfaces.

Industrial imaging systems employ x-ray energy to scan and image a variety of objects, often with multiple components, complex geometries, and/or formed of multiple material types. Such x-ray imaging systems are configured to generate 2D and/or 3D images, viewable via software, which can be used to inspect the object for damage and/or deviations from a desired product.

Ranging in size from compact to large vault options, scans can often provide full internal and external details of the imaged object. This imaging technique can aid in new product development, process development and/or as a quality control measure. Nondestructive testing employing x-ray technology saves time at a lower cost in comparison to other imaging technologies, providing benefits throughout the product life cycle.

During an imaging process, noise, scatter, and/or beam hardening artifacts can negatively impact image fidelity. The x-ray can be delivered over a variety of energy levels, providing a range of beam penetrations. For example, when inspecting large, dense, and/or thick materials, penetration can be difficult with lower energies. Thus, providing a desired amount of energy can improve penetration as well as image quality.

In order to design an industrial x-ray scanner with superior resolution and accuracy while maintaining an easy to use interface, disclosed is an x-ray source cap designed to couple with a target assembly to provide a range of output energies during an imaging process. For example, high speed 3D scanning can be used to inspect objects to provide failure analysis and/or reverse engineer a product. The use of a target assembly employing the disclosed source cap provides an efficient and repeatable process, ensuring components function safely and correctly.

As disclosed herein, a source cap serves as a modified x-ray target, providing improved performance over conventional x-ray targets. For example, the source cap is designed with one or more target surfaces, to which a beam from a radiation delivery system is directed, resulting in an emission of x-rays.

In some examples, a disclosed source cap has two or more flat surfaces, each of which hosts a target material within a target area. In some examples, the source cap has one or more curved surfaces, with a target material being attached to the curved surface, or embedded within a recess of the curved surface.

Each target surface is configured to receive an energy beam at the target material. The disclosed source cap, fitted with one or more targets, has a fit and function similar to conventional sources, such that the disclosed source cap can be secured to conventional anode assemblies, which can be employed in conventional radiation delivery systems.

However, the disclosed source cap provides superior thermal distribution, while each target may prove more durable than conventional x-ray source surfaces. Thus, the disclosed source cap provides extended useful life for an anode source, while delivering improved performance yielding enhanced brightness and/or sharper images.

Conventional designs employ a solid tungsten cap, to which energy is applied to produce x-rays. However, the solid tungsten cap offers limited heat capacity. Conventional caps also lack mounted or inlaid targets on the target surfaces (e.g., a diamond target material), which serve to distribute heat and enhance durability, and therefore the useful life, of the disclosed source cap.

In addition to the advantages stemming from the disclosed source cap, disclosed is a radiation delivery assembly, which is designed to more efficiently remove heat generated as a byproduct during x-ray production. The assembly may incorporate one or more of a heat spreader, modified cooling channels, and/or materials to result in improved thermal conductivity of the assembly.

As a result, radiation delivery systems that employ the disclosed source cap and/or assembly yield improved image brightness. For instance, the delivery system is capable of operating at higher watt densities, which yield higher x-ray flux, thereby providing a brighter image.

Additionally or alternatively, higher watt density delivery can be directed as a smaller focal spot size, which provides a higher resolution image of the specific feature being imaged.

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

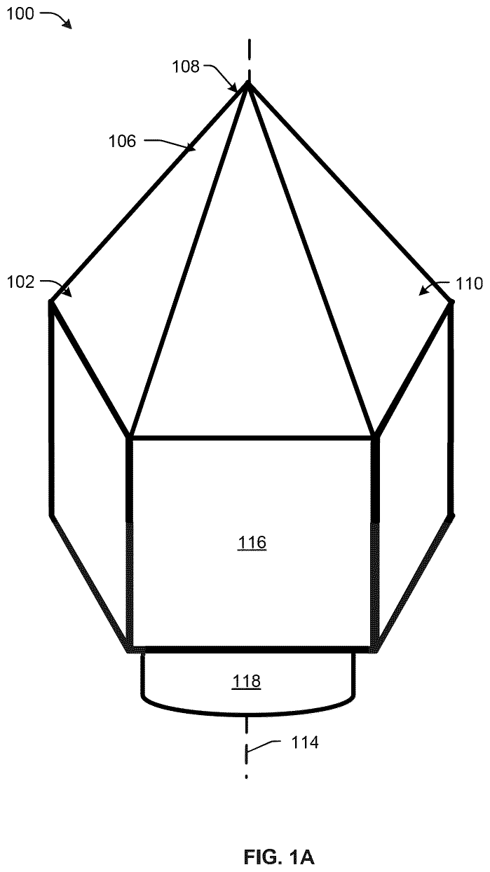

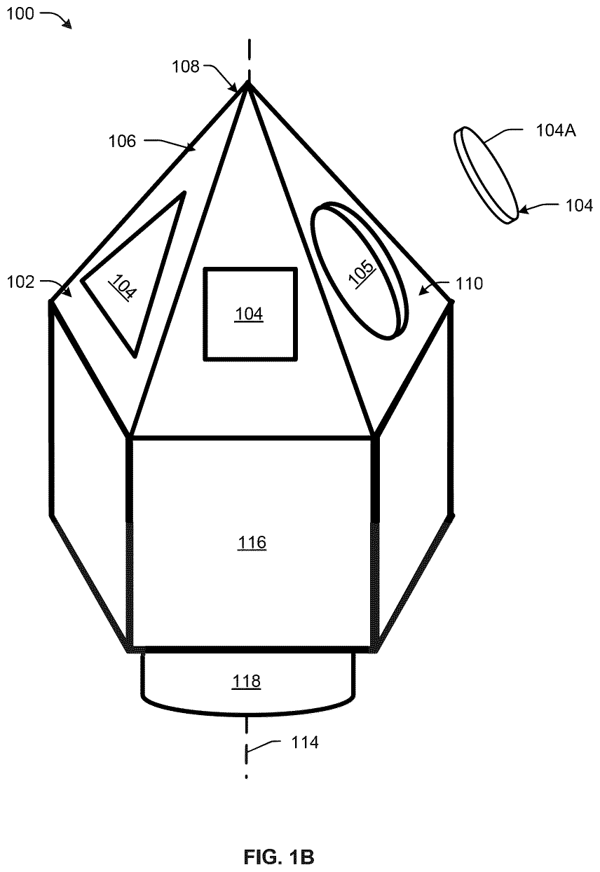

Turning now to the figures, FIGS. 1A and 1B illustrate perspective views of an example source cap 100 to with one or more target surfaces or facets 102, in accordance with aspects of this disclosure.

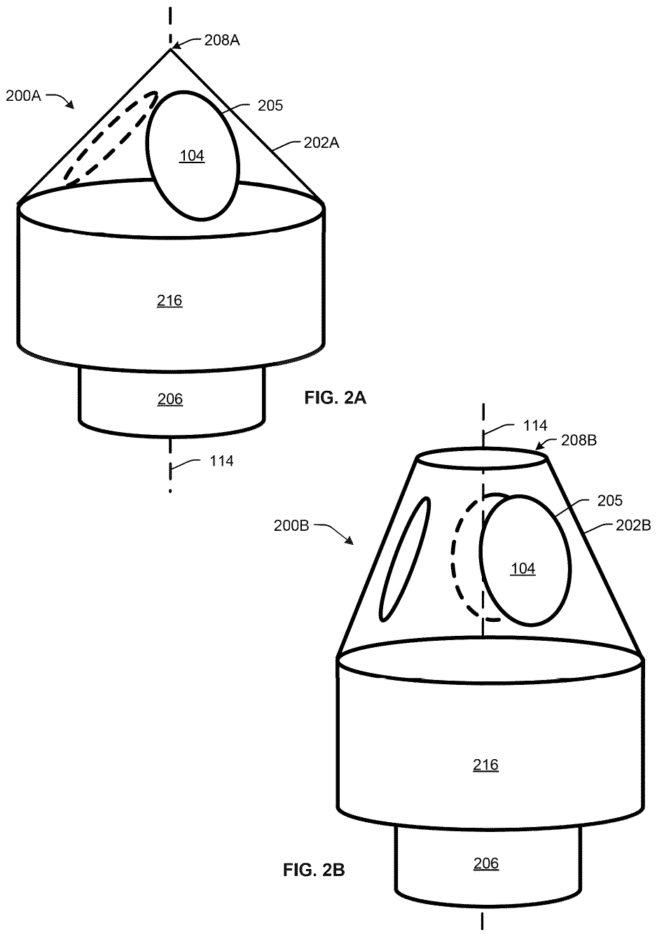

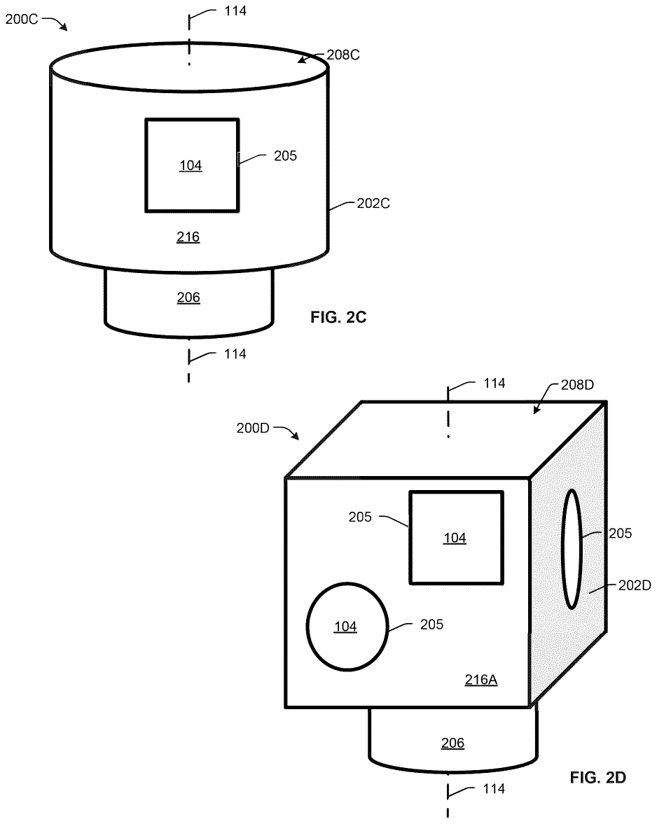

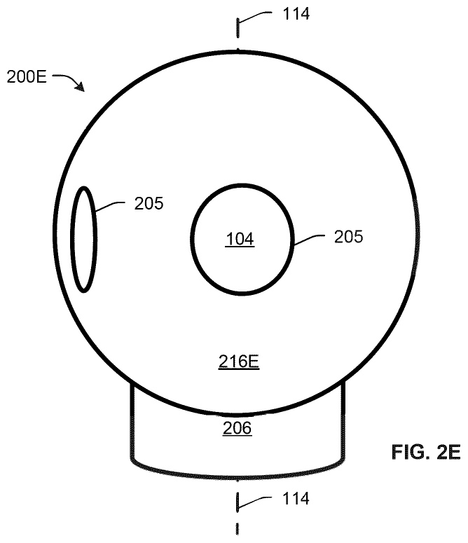

As shown in FIG. 1A, a source cap 100 for an anode target for a radiation delivery is provided. The source cap 100 includes a stem 118 supporting a base 116, on which one or more facets 102 are arranged. Although illustrated with a generally triangular shape, the target surfaces may be any geometric shape (e.g., square, rectangle, trapezoid, circle, etc.) and/or size to result in a desired profile of the source cap 100 (as shown in example FIGS. 2A to 2E). FIG. 1A shows facet 102 as a first target surface having a first corner 108 (e.g., tip) and a first base 110 (adjacent the supporting base 116), with the target surface being adjacent a second facet target surface. The second target surfaces are arranged at adjacent axial positions about a central axis 114 of the source cap, such that the first and second corners (e.g., 108—of first and second target surfaces) meet at a point aligned with the central axis.

In the example of FIG. 1A, bases 110 of the facets 102 are arranged opposite the peak, or first and second corners.

Although adjacent target surfaces are illustrated as having a second corner and a second base similar to the first target surface, in some examples additional and/or adjacent target surfaces may have different geometries, shapes, and/or sizes, depending on a particular application.

As shown in FIG. 1B, each facet 102 can include a recess 105 in which to mount a target 104. As shown, the recesses 105 are configured to support the targets 104 such that a surface 104A of the target 104 is exposed once mounted within the recess 105. In some examples, the surface 104A may be coplanar with a surface 102A of the target surface 102. In some examples, the target 104 is mounted to an external surface of the target surfaces 102, and supported at least by a metallic coating (e.g., tungsten).

In some examples, one or more of the targets 104 are formed of a material to receive an energy beam (e.g., a durable, heat resistant material such as a diamond material), and/or formed in a shape to utilize the surface area of the target surface 102 (e.g., a disk shape). In some examples, targets can include a variety of geometries, shapes, and sizes, including triangular, square, rectangular, and oblong, as a list of non-limiting examples.

The source cap 100 is formed of a material selected for electrical and/or thermal conductivity, receive and support a desired number of targets, and/or accept a durable coating. For instance, the source cap can be formed of copper, stainless steel, aluminum, and/or gold, as a list of non-limiting examples. Further, the source cap (and the targets) can be coated with tungsten or other suitable plating material.

Advantageously, the disclosed source cap yields significantly improved thermal performance. For example, the maximum temperature on the target and average temperature in the copper heat sink of diamond-tipped targets are significantly lower than a conventional, solid tungsten target.

Thus, at 100 W of power and a 120 um beam diameter, heat is more easily distributed, and far less localized at the point of impact (e.g., due in part to the inlaid target material and/or applied coatings). As a result, the source cap degrades less quickly and the useful life of the target is extended, in comparison to conventional targets.

The source cap 100 illustrated in FIGS. 1A and 1B may include multiple facets 102 configured as distinct target surfaces to support targets and receive an energy beam. However, a number of alternatives are covered by the concepts disclosed herein. For instance, FIGS. 2A to 2E illustrate example alternative source caps.

As shown in FIG. 2A, source cap 200A has a generally conical shape and source cap 200B having a generally frustroconical shape, as shown in FIG. 2B. The source cap 200A has a stem 206 and base 216, on which a conical target surface 202A and a frustroconical target surface 202B are formed. Thus, target surfaces 202A and 202B represent distinct target zones, which may include a one or more targets 104, which may be coated with tungsten. In some examples, or more recesses 205 can be formed in the surface 202A, into which one or more targets 104 may be inserted. Similar to source cap 100, the conical target cap can end in a peak 208A coaxial with axis 114.

Source cap 200B similarly includes a target surface 202B, which can have one or more targets 104 and an application of a coating material. Due to its geometry, the source cap 200B further includes a top (generally planar) surface 208B, which may aid in placement of source cap within a radiation delivery system and/or distribute heat during an imaging process.

FIGS. 2C to 2E illustrate alternative embodiments of the disclosed source cap. FIG. 2C provides a source cap 200C with a generally cylindrical surface 202C to support one or more targets 104. FIG. 2D provides a source cap 200D with a generally cuboidal shape, with four vertically oriented surfaces 202D, each of which being configured to support one or more targets 104. FIG. 2E provides a source cap 200E with a generally spherical shape 202E. As such, any portion of the surface 202E may receive and/or support one or more targets 104.

Each source cap can be oriented to change the target surface and/or target to receive the energy beam. If bombardment of the target and/or target surface has degraded the performance of the source cap, the orientation of the source cap can be changed (e.g., rotated within the system). The unused target and/or target surface can then receive the energy beam, with renewed imaging capabilities.

As shown, the geometric limitations of the various source cap designs may allow for a greater or lesser number of targets to be incorporated. Although several examples are illustrated, a source cap can be of any suitable geometry, including cylindrical, round, planar, pyramidal, square, and rectangular, as a list of non-limiting examples.

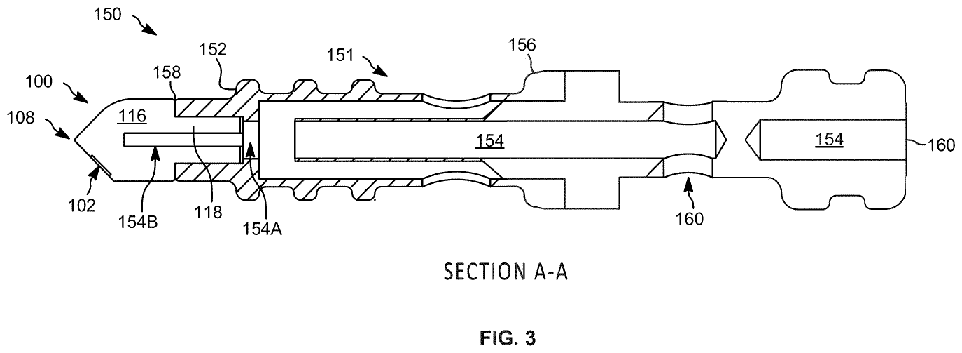

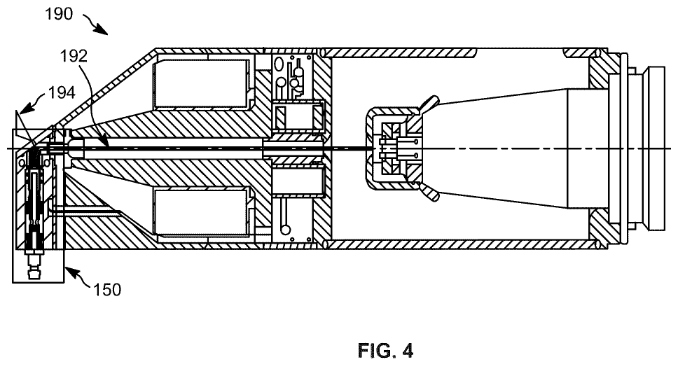

FIG. 3 is a cross-sectional view of the cap of FIGS. 1A, 1B incorporated with a complete assembly. As shown in FIG. 3, the assembly 150 includes one or more annular extensions 152, 156, which may be used to manipulate the assembly and/or secure the assembly into a radiation delivery system (see, e.g., FIG. 4). In some examples, the annular extensions are used to distribute heat. Further, the extensions are not limited to an annular configuration, but may extend as posts, fins, steps, and/or in a spiral fashion (e.g., seconding as threads). In some examples, the body 151 and/or assembly 150 has any of a variety of geometric shapes, including cuboid, and/or pyramidal, as a list of non-limiting examples.

The body 151 of the assembly may include one or more cooling channels 154 extending through a portion of the body. The channel(s) 154 may be wholly housed within the assembly 150, and/or may extend up to the base 118, as shown by channel 154A. In some examples, the source cap 100 may include one or more channels 154B to further distribute heat on the source cap. This can be done by circulating a fluid through the channels 154-154B, which can be introduced and drained through one or more openings 160 that extend through a sidewall and/or end of the body, the cooling channel to receive a cooling fluid during a radiation delivery operation.

In some examples, the metallic source cap 100 can be fused to the assembly body 151 by brazing or other similar technique. For instance, the assembly body 151 may comprise one or more metals and/or metallic alloys (e.g., tungsten, gold, copper, aluminum, stainless steel, etc.), suitable to support the source cap 100 and distribute heat during an imaging process.

Although the source cap 100 and the body 151 are illustrated as separate components, the assembly 150 could be formed as a single unit. This could include forming the components/assembly from a common material (e.g., copper, stainless steel, etc.), and/or employing different materials (e.g., in forging the piece, 3D printing, etc.).

The outer diameter of the source cap 100, here defined by the diameter of the base 116, can be machined after brazing, with the intention of achieving a flush brazed joint 158 with the body of the assembly 150. In some sections, the braze has not filled the joint completely, but is in effect leak tight. In some examples, brazing and machining results in a flush joint 158. In some examples, the targets 104 (mounted within respective recesses) are brazed to fill the joint between the target and the recess (e.g., the diamond disk to the copper source cap material).

In some examples, once the targets 104 are inserted into the recesses 102, a coating can be applied over the targets and/or the source cap surface. For instance, a conductive, metallic surface coat can be applied (e.g., tungsten, gold, copper, aluminum, stainless steel, etc.). This protects the targets and the source cap, and provides a conductive pathway during an imaging process.

For example, a tungsten coating can be applied to the source cap (e.g., a 10 um layer), which adheres to the surface of the source cap and the targets. In some examples, cracks or other imperfections in the surface of the source cap or the target can be eradicated by adjusting the tungsten deposition settings and/or amount.

In some examples, the amount of tungsten applied to the source cap is uniform (e.g., over each target surface, over each target, etc.). In some examples, the amount of tungsten is selectively applied, such that one or more targets and/or target surfaces may have a different amount of coating than another target or target surface.

FIG. 4 illustrates a cross-sectional views of an example anode assembly 150 arranged within a radiation delivery system 190. Thus, a disclosed source cap is arranged within the system 190 to receive energy 192, thereby generating x-rays 194 to be projected at an object for imaging. In some examples, the radiation delivery system is an in-line monochromator or polychromatic x-ray source.

As utilized herein, “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y and z.” As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A multifaceted source cap for an anode target for a radiation delivery system comprising:
a first facet covered in a metallic coating; and
a second facet covered in the metallic coating, each facet arranged about a common axis extending through the source cap.

2. The multifaceted source cap of claim 1, wherein each facet is arranged at an angle to the common axis.

3. The multifaceted source cap of claim 1, wherein each facet of the multifaceted source cap is defined by a geometric shape, the geometric shape is substantially triangular, rectangular, square, circular, or trapezoidal.

4. The multifaceted source cap of claim 1, further comprising third, fourth and fifth facets, wherein each of the first, second, third, fourth and fifth facets meet at a peak aligned with the central axis.

5. The multifaceted source cap of claim 1, wherein each of the first, second, third, fourth and fifth facets are supported by a base arranged on the source cap opposite the peak.

6. The multifaceted source cap of claim 1, further comprising a base and a stem, the stem to support the base and mount within an anode target assembly.

7. The multifaceted source cap of claim 6, wherein the stem has a generally cylindrical shape configured to be inserted into a body of the anode target assembly.

8. The multifaceted source cap of claim 6, wherein the base is defined by a geometric shape having a number of sides different from the number of facets of the multifaceted source cap.

9. The multifaceted source cap of claim 1, wherein the base is defined by a geometric shape having a number of sides equal to the number of facets of the multifaceted source cap.

10. The multifaceted source cap of claim 9, wherein the base comprises three, four, five, six, seven, or eight sides.

11. The multifaceted source cap of claim 1, wherein the metallic coating comprises a tungsten material, wherein the source cap comprises a copper material, or the first facet or the second facet comprises a curved surface.

12. A multifaceted source cap for an anode target for a radiation delivery system comprising:
a first facet covered in a metallic coating;
a second facet covered in the metallic coating; and
a cooling channel extending into the source cap.

13. The multifaceted source cap of claim 12, wherein the cooling channel is aligned with a central axis of the source cap.

14. The multifaceted source cap of claim 12, wherein the cooling channel includes two or more channels within the source cap.

15. The multifaceted source cap of claim 12, wherein the source cap comprises a base and a stem, the stem configured to be inserted into a body of an anode target assembly.

16. The multifaceted source cap of claim 15, wherein the cooling channel is defined by a first end open to the body of the anode target assembly, and a second, closed end within the source cap.

17. An anode target assembly for a radiation delivery system comprising:
a body with a first end and a second end, wherein the body includes a first cooling channel that extends through the body; and
a multifaceted source cap comprising a second cooling channel extending into the source cap, the source cap being arranged at the first end of the body.

18. The anode target assembly of claim 17, wherein the first cooling channel of the body is fluidly connected to the second cooling channel of the source cap.

19. The anode target assembly of claim 17, wherein the body further comprises one or more openings that extend through a sidewall or end of the body, the first cooling channel being fluidly connected to the one or more openings to channel a cooling fluid to the first cooling channel during a radiation delivery operation.

20. The anode target assembly of claim 17, wherein the source cap is fused to the body at the first end.
